(19) United States
(12) Patent Application Publication
(10) Pub. No.: US 2007/0295837 A1
(43) Pub. Date: Dec. 27, 2007

(54) Dual-flow faucet head

(75) Inventors: Joachim Stork, Kippenheim (DE); Jurgen Walter, Lahr (DE); Jurgen Kobler, Friesenheim (DE)

Correspondence Address: K.F. ROSS P.C., 5683 RIVERDALE AVENUE, SUITE 203 BOX 900, BRONX, NY, 10471-0900, US

(73) Assignee: Grohe AG

(21) Appl. No.: 11/803,340

(22) Filed: May 14, 2007

(30) Foreign Application Priority Data
May 31, 2006 (DE) 102006025785.5

(51) Int. Cl. A62C 31/00

(52) U.S. Cl. 239/443; 239/436

(57) ABSTRACT

A faucet head has a tubular and arcuate casing having an inlet end connectable to a pressurized-water supply and an outlet end. An integral core unit in the casing forms a sprayer having a first central inner spray chamber at the outlet end centered on an outlet-end spray axis and a second generally coaxial annular outer spray chamber at the outlet end around the inner chamber. The sprayer further forms inner and outer holes open generally parallel to the outlet-end axis from the spray chambers. The cure unit further forms a valve housing having an inlet port and a pair of offset first and second outlet ports. The valve housing extends along an axis offset radially from the outlet-end axis. The core unit forms also an inlet conduit forming an inlet passage extending between the in let port and the inlet end of the casing and first and second outlet conduits.

### FIELD OF THE INVENTION

The present invention relates to a dual-flow faucet head. More particularly this invention concerns such a head adapted to be mounted on the end of a faucet spout and even pulled therefrom for use as a sprayer.

### BACKGROUND OF THE INVENTION

A typical faucet such as used in a kitchen has a spout mounted on the counter or wall and having an outer end provided with a pull-out dual-flow head connected to a hose extending back down through the spout to a mixing valve. The head can be set either to emit a single aerated central stream, for instance for filling a pot, or an annular spray for washing or rinsing something. In particular when used as a sprayer, this head is pulled out of the faucet's spout and directed at the object being sprayed.

Examples of such devices are U.S. Pat. Nos. 6,085,790 and 6,808,131 and in published US patent application 2005/0189438. In the case of the faucet head described in the first-cited document, a sprayer is provided at the outlet end of a curved casing with a changeover valve mounted concentrically to the water discharge direction. The sprayer has a first central outlet chamber surrounded by a second, substantially circular outlet chamber. A central hole or holes is assigned to the first outlet chamber, in which outlet an aerator or similar water-discharge nozzle is inserted, while a plurality of individual second holes are assigned to the second outlet chamber to creating a multistream spray. By providing the changeover valve with a linearly slidable changeover valve and the sprayer at the outlet end of the fitting housing, its size and shape is relatively limited. This limits design options.

Each of the two other above-cited publications describes a faucet head whose casing is designed as straight or curved like a cylindrical pipe, the outlet end defining a plane extending perpendicular to the longitudinal axis of the tubular casing.

### OBJECTS OF THE INVENTION

It is therefore an object of the present invention to provide an improved dual-flow faucet head.

Another object is the provision of such an improved dual-flow faucet head that overcomes the above-given disadvantages, in particular that whose valve and sprayer are compact and can fit inside a tubular, curved casing with an appealing design providing ergonomically advantageous operation of the valve.

### SUMMARY OF THE INVENTION

A faucet head has according to the invention a tubular and arcuate casing having an inlet end connectable to a pressurized-water supply and an outlet end. An integral core unit in the casing forms a sprayer having a first central inner spray chamber at the outlet end centered on an outlet-end spray axis and a second generally coaxial annular outer spray chamber at the outlet end around the inner chamber. The sprayer further forms inner and outer holes open generally parallel to the outlet-end axis from the spray chambers. The cure unit further forms a valve housing having an inlet port and a pair of offset first and second outlet ports. The valve housing extends along an axis offset radially from the outlet-end axis. The core unit forms also an inlet conduit forming an inlet passage extending between the inlet port and the inlet end of the casing and first and second outlet conduits forming first and second outlet passages each extending between a respective one of the outlet ports and a respective one of the spray chambers. A valve body can shift in the valve housing between one end position directing flow from the inlet port to only one of the outlet ports and an opposite end position directing flow from the inlet port only to the other of the outlet ports. An actuating element can shift on the housing and is coupled to the valve body for moving the valve body between its end positions. The casing is formed with an aperture through which the actuating element is operable manually from outside the casing.

With the invention, the housings of the changeover valve and the sprayer, together with the conduits extending from the valve to the sprayer, form a single core unit that is inserted into the casing. The axis of motion of the changeover valve, along which it may be moved between at least two of its end positions, thereby forms an obtuse angle to the water discharge direction as defined by the spray holes. This allows placement of the actuator on the casing in an ergonomically advantageous way as the faucet head may be gripped manually from the front and side, and water dispensed without the hand getting wet. Gripping around the faucet head in order to control or start the discharge of water is therefore unnecessary with the device according to the invention, which enhances comfortable operation of the faucet head according to the invention.

The core unit designed according to the invention and comprising the housing of the valve, the sprayer, and the conduits forming passages extending from the valve to the outlet chambers of the sprayer may advantageously be produced as an injection-molded part. It is thereby practical if the second passages leading to the especially circular designed second outlet chamber, or at least the one second passage, is (are) formed as channels unitary with the core unit, open outward, and closed by respective coves. This cover may be glued, welded, especially ultrasonically welded, or connected in another way to the core unit in a watertight fashion.

The core unit of the faucet head according to the invention is suitably designed symmetrically along a plane of symmetry extending through the axis of changeover valve and of the spray holes. The highly compact design of this core unit benefits from the first outlet port of the valve being in direct connection with the first outlet chamber of the sprayer, while the second outlet chamber, which in the normal case extends circularly around the first outlet chamber, is connected via two respective conduits to two outlet ports of the valve, these conduits flanking the valve housing.

As an actuator for the changeover valve, a two-arm lever arranged in an aperture or behind an aperture in the outer surface of the curved casing is a suitable option. This two-arm lever has two end actuating surfaces, one being on an extension of the axis the changeover valve. This means that the necessary motion for operating the two-arm lever or the corresponding actuating surface of the two-arm lever need not be converted into a motion of the changeover valve along its axis of motion, which normally and in the most general sense requires a transmission of some type. Instead, the actuator is operated directly by pressing the actuating surface of the two-arm lever so that it moves from one position to another.

Moreover, an advantageous further development of the invention provides that an inlet conduit forms a passage extending from the inlet end of the casing to the inlet port of the valve that is in the casing, which inlet conduit is designed in a tube that in turn is mounted in the casing. The two-arm lever may suitably be rotatably mounted on this inlet tube. When mounting, it is appropriate if the inlet tube is simply plugged into the inlet port of the valve. For this purpose, the valve has an inlet nipple or socket forming the inlet port. For best feel when operating the actuator and watertight sealing of the casing against the exterior, it is advantageous if the aperture in the casing inside which the actuator is freely exposed is sealed with a flexible or elastomeric cover cap. This cap covers the actuator and its two actuating surfaces. The flexible material forming at least part of the cover enables operation of the actuating surfaces of the actuating lever or element from outside the casing.

It is advantageous if the actuator, after adjustment of the spray (either a central Perlator or aerator jet, a Mouseur or foaming jet, or a needle jet) does not need to be pressed continuously, and the changeover valve instead is self-locking or bistable. This is effected through per-se known springs prestressing the changeover valve in a preferred position and appropriate orientation of the pressurized and unpressurized compartments of the valve to so that the changeover valve is retained in its assumed position due to the water pressure upon actuation and/or motion against the pretension of the spring.

The compact design of the core unit according to the invention comprising the casings of the changeover valve and the sprayers, as well as the passages, makes it possible according to the invention to create a faucet head containing—in an esthetical and ergonomic manner—a tubular casing that is curved and widens toward the outlet end situated in a plane that forms an acute angle to the axis of curvature of the casing. The curved, tubular casing is thus provided with an oval or circular hole at its outlet end with an appealing visual appearance next to the curved structure of the casing, and a small radii of curvature of the relatively short arched casing parts will create enough space for placing the water-jet-forming and valves. Due to the integral design of the housings of the changeover valve and the sprayer in which the housings of both parts are offset manner, the placement of the actuator on the casing may, on the one hand, be done at a sufficient distance from the outlet end provided with the sprayer, so that wetting of the hand is avoided when a user manually grips the device when in front of a washstand or a sink, or on the other, at a position on the device that still makes comfortable handling possible.

It is advantageous when the changeover valve is prestressed into one of its two positions (first position), and during water flow and actuation remains self-locking in the other position, which is feasible due to the pressure of the water and the per-se known spring devices. Upon stopping water flow, e.g. by closing the upstream mixing valve, the changeover valve then automatically moves back into its first position, but may advantageously be moved into its first position—even while the water is running—by operating the actuator. Such valves require a certain minimum overall height, which limits their compactness.

The angular and/or laterally offset configuration of the valve according to the invention relative to the sprayer still ensures a reduced overall height, since in spite of adhering to the minimum height of the switching-unit casing, this relative configuration provides the assembly consisting of the changeover valve and sprayers with a compact design that allows for introduction into a mounting space of reduced height.

### BRIEF DESCRIPTION OF THE DRAWING

The above and other objects, features, and advantages will become more readily apparent from the following description, reference being made to the accompanying drawing in which:

FIG. 1 is a longitudinal section through the head according to the invention in partly exploded view;

FIG. 2 is a perspective view of the core of the faucet head;

FIGS. 3 and 4 are longitudinal sections through the head in alternate flow positions; and

FIG. 5 is a bottom view of the core parts of the head according to the invention.

### SPECIFIC DESCRIPTION

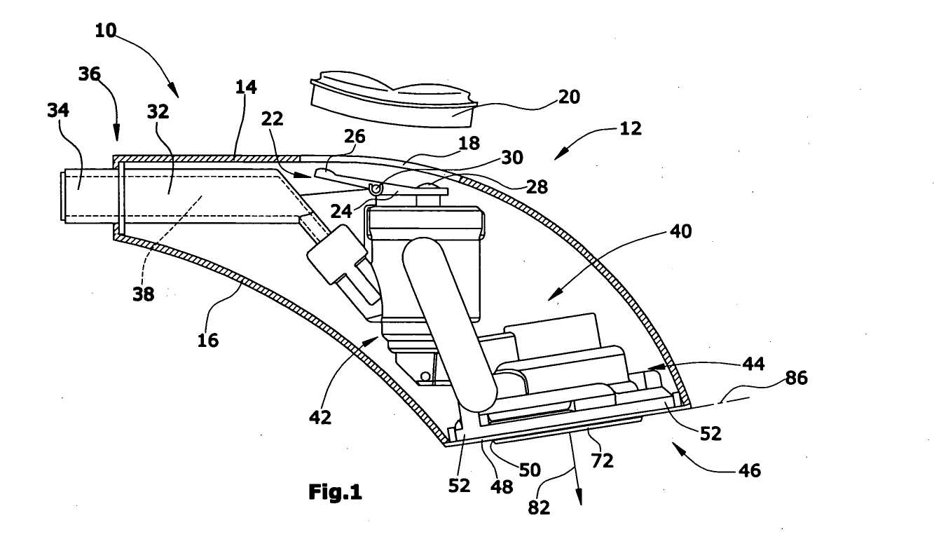

As seen in FIG. 1 a faucet head 10 is attached to a flexible hose 83 that extends back in a retractable and insertable manner in faucet spout 85, especially a kitchen faucet. The faucet head 10 has a tubular, curved casing 12 made, e.g. of plastic and having an outer surface 14 and an inner surface 16, as well as an inlet end 36 centered on an axis 87 and an output end 46 centered on an axis 82 that extends at a large obtuse angle to the axis 87. The casing 12 is formed with an aperture 18 closed by an elastomeric seal 20.

An actuator 22 in the form of a two-arm lever 24 having two actuating surfaces 26 and 28 is located below and actuatable through the seal 20. The lever 24 is mounted rotatably about on a pivot 30 at the inner end of an inlet tube 32 whose outer end 34 is fixed at the inlet side 36 coaxially of the axis 87 with the hose 83. The inlet tube 32 defines an inlet passage 38 leading to a core unit 40 that is injection-molded of plastic as described in more detail below. The inlet tube 32 is unitarily formed with the unit 40, and the actuator 22 and seal 20 are also both injection-molded parts.

The core unit 40 includes a changeover valve 42 and a sprayer 44. While the valve 42 is arranged aligned with a direction of actuation of the actuator 22, the sprayer 44 is provided adjacent to the outlet end 46 of the tubular, curved casing 12. At this outlet end 46, a plate 48 is provided lying in a plane perpendicular o the axis 82 and closing the end 46. It has one or more central holes 50 and a plurality of secondary discharge holes 52 arrayed coaxially in a ring around this first hole 50 by pushing the inner or outer side of the actuator seal 22, one can select either a central water jet (aerator or Mouseur jet) or a circular shower jet.

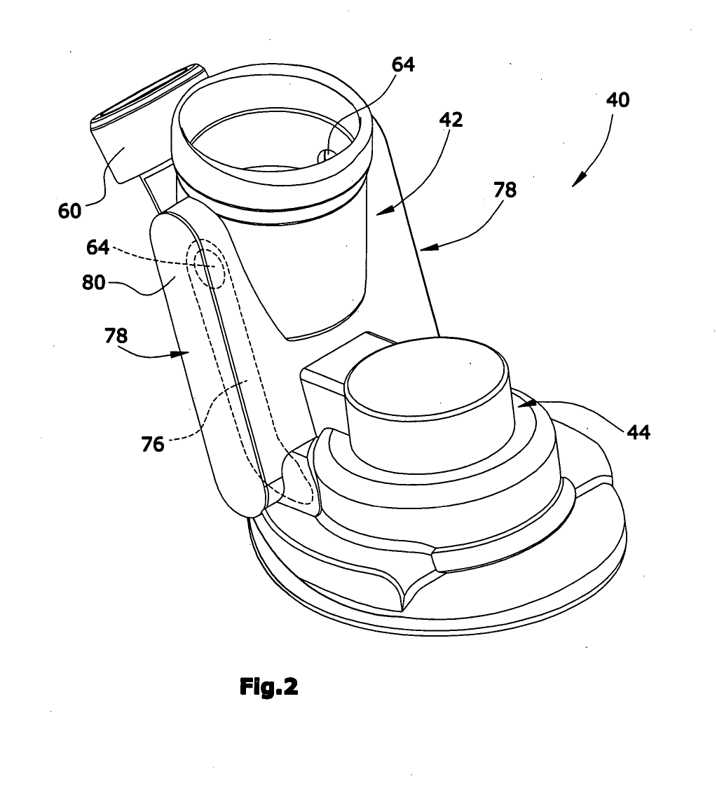

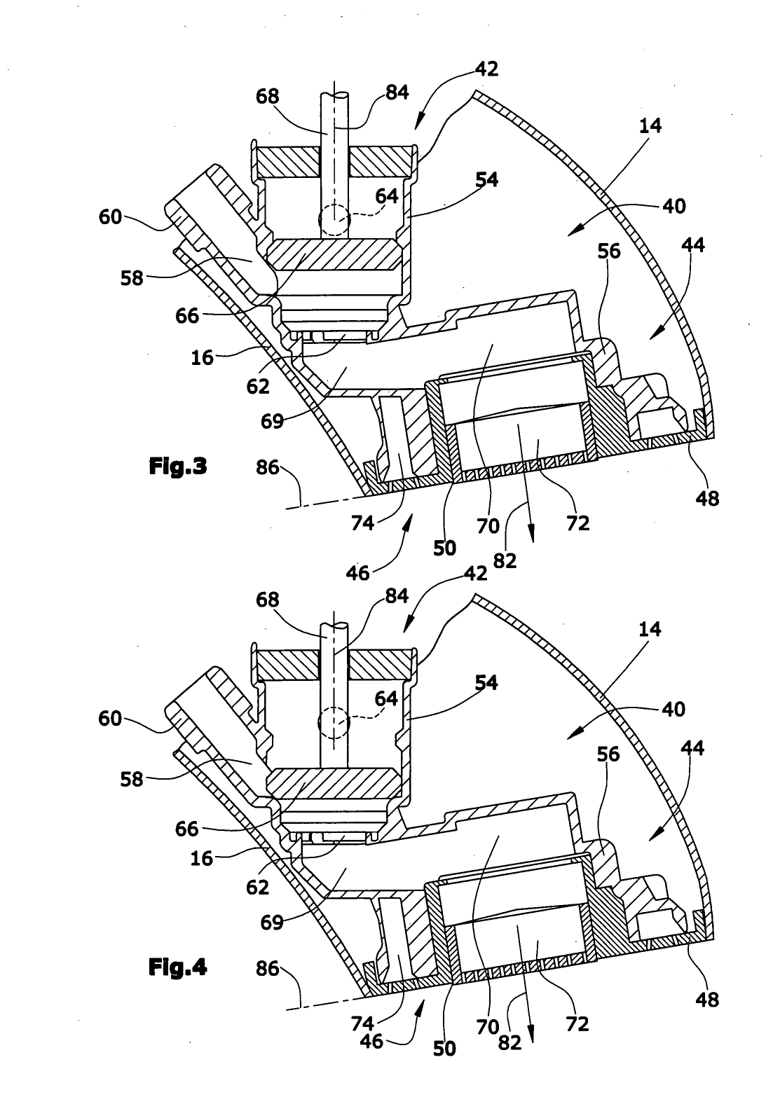

The core unit 40, as shown in FIGS. 2 through 5, comprises parts forming the valve 42 and the sprayer 44. Thus, the core unit 40 has a cylindrical part 54 of the valve 42 and a housing 56 forming the sprayer 44. The housing 54 of the valve 42 is provided with an inlet port 58 designed in this embodiment as tubular nipple 60 fitted to inlet tube 32, the inlet passage 38 fitting tightly into the nipple 60 and/or inlet port 58 of the valve 42. The valve 42 is bistable, that is water pressure holds the valve body 66 in either of its end positions. It has a first outlet port 62 in its cylindrical valve housing 54, and in this embodiment, two second outlet ports 64. A valve body 66 is carried on an actuating stem. 68 shiftable along its axis 84 that extends at a large acute angle to the axis 82. This valve body 66 can be moved by actuation through the seal button 20 between two end positions. In the end position shown in FIG. 3, it blocks flow from the inlet port 58 to the outlet ports 64 and directs it instead through the port 62 and passage 60 to the center spray holes 50. In the other end position shown in FIG. 4, it blocks flow from the inlet port 58 to the outlet port 62 and directs it instead through the ports 64 and the conduits 78 to the outer chamber 74 and thence out through the spray holes 52.

An outer end of the stem 68 is fitted to the end 28 of the lever 24 so that the lever 24 is coupled to this rod 68 and rocking it will shift the valve 42 between its end positions. Normally a spring is provided to urge the lever 24 into one of its end positions so that, when pressure is relieved, the system will revert to a default position, typically center spray through the holes 50.

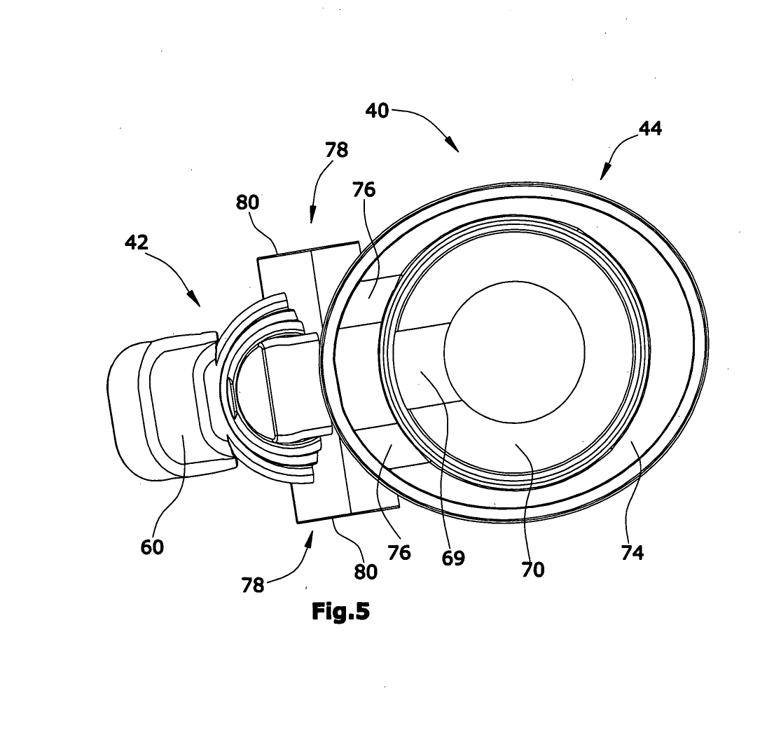

As can be seen in FIGS. 3 and 4, the first outlet port 62 of valve 42 is directly connected via a passage 69 with a central outlet chamber 70 of the housing 56 of the sprayer 44 whence water flows out as a center spray via holes 50 of plate 48 sealing the sprayer 44, after through passing an aerator 72 provided upstream of the holes 50. The housing 56 of the sprayer 44 also forms a second annularly circular outlet chamber 74 separated from the first outlet chamber 70 and connected by two second passages 76 (FIG. 2) with the second outlet ports 64 of the cylindrical valve housing 54 of valve 42. Both these two passages 76 are situated on opposite sides 78 of the core unit 40, and are tightly sealed against the sides 78 by seals 80 in the form of oblong covers. These covers 80 are ultrasonically welded to with core unit 40. The second inlet passages 76 open into the second circular outlet chamber 74 of the housing 56 of the sprayer 44, which is especially apparent in FIG. 5. From there, water emerges from the outlet end 46 of the faucet head 10 as an annular shower jet via the second holes 52 of the plate 48.

The water-discharge axis 82 defined by the holes 50 and 52 forms an acute angle to the axis 84 of the changeover valve 66. In other words, the discharge surface 86 mounted from outlet end 46 and defined by holes 50 and 52 also follows an acute angle relative to the axis of motion 84 of changeover valve 66. Here the valve 42 is offset from the sprayer 44 and in fact is centered on an axis 84 that is neither parallel nor perpendicular to the axis 82 of the outlet end 46. Thus this entire core unit 40 can be tucked inside the attractively and ergonomically shaped casing 12. Being one piece it is quite strong. Furthermore, the casing 14 can be made according to a wide range of designs, all using the same core unit 40 so as to hold down manufacturing costs considerably.

We claim:

1. A faucet head comprising:
a tubular and arcuate casing having an inlet end connectable to a pressurized-water supply and an outlet end;
an integral core unit in the casing forming
a sprayer having a first central inner spray chamber at the outlet end centered on an outlet-end spray axis and a second generally coaxial annular outer spray chamber at the outlet end around the inner chamber, the sprayer further forming inner and outer holes open generally parallel to the outlet-end axis from the spray chambers,
a valve housing having an inlet port and a pair of offset first and second outlet ports, the valve housing extending along an axis offset radially from the outlet-end axis,
an inlet conduit forming an inlet passage extending between the inlet port and the inlet end of the casing, and
first and second outlet conduits forming first and second outlet passages each extending between a respective one of the outlet ports and a respective one of the spray chambers;
a valve body shiftable in the valve housing between one end position directing flow from the inlet port to only one of the outlet ports and an opposite end position directing flow from the inlet port only to the other of the outlet ports; and
an actuating element shiftable on the housing and coupled to the valve body for moving the valve body between its end positions, the casing being formed with an aperture through which the actuating element is operable manually from outside the casing.

2. The faucet head defined in claim 1 wherein the core unit is wholly housed inside the casing.

3. The faucet head defined in claim 1 wherein the valve housing is formed with two of the outlet ports connected via a respective one of the conduits to second spray chamber.

4. The faucet head defined in claim 1 wherein at least one of the outlet-port conduits is constituted by an outwardly open channel formed integrally with the valve body and a cover fixed over the channel.

5. The faucet head defined in claim 4 wherein the valve housing is formed with two of the second outlet ports connected via respective ones of the conduits to the second spray chamber, the conduits of the second outlet ports being formed as outwardly open channels flanking the valve housing and each provided with a cover fixed over the channel.

6. The faucet head defined in claim 4 wherein the covers are welded over the respective channels.

7. The faucet head defined in claim 1 wherein the actuating element is a two-arm rocker lever.

8. The faucet head defined in claim 7 wherein the lever is centrally pivotal and has a pair of ends actuatable from outside the casing through the aperture.

9. The faucet head defined in claim 8, further comprising
a flexible cover sealingly closing the aperture and through which the actuating element is operable.

10. The faucet head defined in claim 1 wherein the casing is wholly tubular and of increasing inside dimension from the inlet end to the outlet end.

11. The faucet head defined in claim 10 wherein the inlet end is centered on and extends along an inlet-end axis nonperpendicular to the outlet-end axis.

12. The faucet head defined in claim 10 wherein the core unit can fit through the outlet end.

13. A faucet head for a sanitary appliance, the faucet head comprising:
a tubular and arcuate casing having an inlet end for intake of pressurized water and an outlet end for discharge of the pressurized water,
a sprayer arranged in the casing at the outlet end thereof, the sprayer comprising a housing including at least two outlet chambers, the first outlet chamber having assigned thereto a first discharge hole of the sprayer for discharge of a water jet, and the second outlet chamber having assigned thereto a plurality of second discharge holes of the sprayer for discharge of a spray jet comprising a plurality of individual water jets, and
a changeover valve adapted to be manually actuated by an actuator, comprising a housing having an inlet port in fluid connection with the inlet end of the casing, a valve body arranged for movement along an axis of motion, and at least two outlet ports of which a first outlet port is via a first passage in fluid connection with the first outlet chamber, and at least one second outlet port is via at least one second passage in fluid connection with the second outlet chamber of the sprayer,
wherein
the valve body is arranged at a lateral offset and/or inclination relative to the group of the first outlet port and the second outlet ports, the axis of motion of the valve body extending at an angle relative to the water discharge direction defined by the group of the first and second outlet ports, and
the housing of the sprayer along with the two outlet chambers of the housing, the housing of the changeover valve, the first passage and the at least one second passage are accommodated in the casing as an integral core unit.

14. The faucet head according to claim 13 wherein the housing of the changeover valve comprises two second Outlet ports, each having a respective second passage extending to the second outlet chamber of the sprayer.

15. The faucet head according to claim 13 wherein the at least one or each second passage is arranged in an outer region of the core unit and is sealed to the exterior of the core unit by a closure element tightly connected to the core unit.

16. The faucet head according to claim 15 wherein the closure element is welded, particularly ultrasonically welded, to the core unit.

17. The faucet head according to claim 14 wherein the two second passages are arranged on opposite outer sides or outer regions of the core unit.

18. The faucet head according to claim 13 wherein the two outlet chambers of the sprayer are closed towards the outlet end of the casing by a plate element comprising the first discharge hole and the plurality of second discharge holes.

19. The faucet head according to claim 13 wherein the actuator is a lever comprising two actuating surfaces, the lever being arranged in the region of the outer wall of the arcuate casing, one of the actuating surfaces being arranged on an extension of the axis of motion of the valve body.

20. The faucet head according to claim 19 wherein the casing is fitted with an inlet tube in which an inlet passage extends from the inlet end to the inlet port of the changeover valve.

21. The faucet head according to claim 19 wherein the lever is arranged to be turned on the inlet tube.

22. The faucet head according to claim 20 wherein the housing of the changeover valve is provided with an inlet connector forming an inlet opening and having connected thereto inlet tube by a plug-type connection.

23. The faucet head according to claim 19 wherein the actuator is arranged within and/or behind an opening in the outer wall region of the casing and that the opening is closed by a cover element made of a flexible material and adapted to be acted on manually for actuating the lever.

24. The faucet head according to claim 20 wherein the casing is widened from the inlet end toward the outlet end and/or the outlet end defines a plane extending at an acute angle relative to the axis of curvature of the casing and wherein the preassembled core unit comprising the mutually connected inlet tube, sprayer and changeover valve can fit into the casing through the outlet end.
